(19) United States
(12) Patent Application Publication
(10) Pub. No.: US 2025/0322294 A1
(43) Pub. Date: Oct. 16, 2025

(54) GENERATING DIGITAL CONTENT CONSISTENT WITH CONTEXT-SPECIFIC GUIDELINES UTILIZING PROMPT AUGMENTATION AND MODEL TUNING

(71) Applicant: Adobe Inc., San Jose, CA (US)

(72) Inventors: Varsha Sankar, Mountain View, CA (US); Shankar Venkitachalam, San Jose, CA (US); Meghanath Macha Yadagiri, San Jose, CA (US); Maryam Moosaei, San Jose, CA (US); Deepak Pai, Sunnyvale, CA (US); Debraj Debashish Basu, Los Angeles, CA (US)

(21) Appl. No.: 18/634,240

(22) Filed: Apr. 12, 2024

(51) Int. Cl. G06N 20/00

(52) U.S. Cl. CPC G06N 20/00

(57) ABSTRACT

The present disclosure is directed toward systems, methods, and non-transitory computer readable media that provide a contextual content generation system that trains and implements a unique machine learning architecture to generate context-specific digital content items based on a digital guideline document. In particular, the disclosed systems select a content generation method from among prompt engineering and/or updating one or more machine learning models to generate digital content. For example, the disclosed systems utilize machine learning models to extract key elements from a digital guideline document comprising context-specific guidelines for digital content. Further, the disclosed systems generate an augmented prompt comprising indications of key elements from the digital guideline document. In addition, the disclosed systems select a content generation method from among prompt engineering and/or updating machine learning models to generate the digital content item which incorporates digital content corresponding to the context-specific guidelines based on the augmented prompt.

### BACKGROUND

Advancements in computing devices and computing systems have led to an array of specialized generative machine learning models, such as large language models, each with unique capabilities and features. For example, some large language models have been developed to generate digital content in response to natural language prompts, ranging from single-phrase responses to more complex responses based on complex requirements. To facilitate such functionality, existing large language models are trained on comprehensive datasets that encompass a multitude of topics across various disciplines. Many entities utilize generative machine learning models (including large language models) to generate various types of digital image, text, or other content items for a number of different applications. Due to the broad nature of digital content used to train existing generative models, however, many such models exhibit deficiencies regarding flexibility, accuracy, and computational efficiency, especially when generating digital content items with specific restrictions based on entity guidelines.

### SUMMARY

One or more embodiments provide benefits and/or solve one or more of the foregoing or other problems in the art with systems, methods, and non-transitory computer readable storage media by utilizing prompt augmentation and model fine-tuning to generate digital content that is consistent with context-specific guidelines. Specifically, the disclosed systems utilize machine-learning models to extract key elements of a digital guideline document indicating context-specific guidelines (e.g., including visual, semantic, or other contextual characteristics) to use in augmenting a prompt for generating digital content consistent with the context-specific guidelines. Additionally, the disclosed systems determine whether to supplement the prompt augmentation with model fine-tuning and/or reinforcement learning (e.g., based on how well the generated content adheres to the context-specific guidelines). In particular, the disclosed systems validate the digital content items in relation to the extracted key elements to determine the adherence of the digital content items to the context-specific guidelines. Accordingly, the disclosed systems dynamically select the optimal approach (e.g., prompt augmentation, model fine-tuning, or model training) for generating digital content that adheres to the context-specific guidelines.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a diagram of an example environment of a contextual content generation system in accordance with one or more embodiments;

FIG. 2 illustrates an example overview of using a contextual content generation system to generate a digital content item according to context-specific guidelines in accordance with one or more embodiments;

FIG. 3 illustrates an example of dynamically utilizing one or more machine learning models to generate a digital content item in accordance with one or more embodiments.

FIG. 4 illustrates an example of utilizing a digital guideline retrieval machine learning model to extract key elements from a digital guideline document in accordance with one or more embodiments;

FIG. 5 illustrates an example of utilizing a content generation machine learning model to generate a digital content item based on an augmented prompt in accordance with one or more embodiments;

FIG. 6 illustrates an example of fine-tuning a content generation machine learning model in accordance with one or more embodiments;

FIG. 7 illustrates an example of utilizing reinforcement learning with a reward model to adjust parameters of a content generation machine learning model in accordance with one or more embodiments;

FIG. 8 illustrates an example of the contextual content generation system generating a prompt for performing a key element evaluation based on the context-specific guidelines in accordance with one or more embodiments;

FIG. 9 illustrates a diagram of a contextual content generation system in accordance with one or more embodiments;

FIG. 10 illustrates a flowchart of a series of acts for generating digital content by utilizing key elements indicating context-specific guidelines for prompt augmentation in accordance with one or more embodiments;

FIG. 11 illustrates a flowchart of a series of acts for generating an updated digital content item in response to validating a generated digital content item relative to context-specific guidelines in accordance with one or more embodiments; and

FIG. 12 illustrates a block diagram of an example computing device in accordance with one or more embodiments.

### DETAILED DESCRIPTION

This disclosure describes one or more embodiments that utilize a contextual content generation system to utilize one or more machine learning models (e.g., large language models and/or other generative machine learning models) to generate digital content items that adhere to context-specific guidelines in digital guideline documents. In many scenarios, client devices interact with generative models to generate digital content having content related to a particular purpose (e.g., for distribution in a marketing campaign) and adheres to specific contextual guidelines related to visual, stylistic, categorical, or other content characteristics. To provide digital content that conforms to such context-specific requirements, the contextual content generation system utilizes machine learning to determine the context-specific guidelines and select an appropriate content generation approach to generate digital content that adheres to the context-specific guidelines. More specifically, the contextual content generation system leverages various machine-learning models to perform prompt augmentation, model fine-tuning, and/or additional model training to generate accurate digital content. Indeed, the contextual content generation system determines whether to utilize a combination of one or more of the prompt engineering/augmentation, model fine-tuning, and/or reinforced learning based on the adherence of the digital content to the context-specific guidelines.

As just mentioned, in one or more embodiments, the contextual content generation system utilizes various machine learning models to generate digital content in line with context-specific guidelines. For example, the contextual content generation system utilizes a digital guideline retrieval machine learning model to extract or identify key elements associated with context-specific guidelines from one or more digital guideline documents. For example, the contextual content generation system utilizes the digital guideline retrieval machine learning model to retrieve key elements that correspond to one or more context-specific guidelines from one or more stored digital guideline documents that include websites, digital documents (e.g., PDFs, word processing documents, digital images), or raw text.

Furthermore, in some cases, the contextual content generation system utilizes the extracted key elements to generate an augmented prompt for generating digital content corresponding to the context-specific guidelines. In particular, the contextual content generation system generates the augmented prompt by incorporating the key elements with additional context such as content characteristics and/or historical digital content items to generate digital content items that correspond to the context-specific guidelines from the digital guideline document. For instance, the contextual content generation system receives an initial prompt from a user device that includes a request to generate digital content (e.g., a marketing email) based on context-specific guidelines (e.g., brand guidelines) and enhances the initial prompt to include the extracted key elements from the digital guideline document. Utilizing the enhanced prompt, contextual content generation system prompts a content generation machine learning model to generate digital content based on the context-specific guidelines.

In addition, in some embodiments, the contextual content generation system fine-tunes the content generation machine learning model (e.g., via few-shot tuning). For example, the contextual content generation system determines the adherence of the generated digital content items with the context-specific guidelines of the digital guideline document based on precision values indicating how closely the digital content items adhere to the context-specific guidelines. In various embodiments, in response to determining that the digital content items do not adhere to the context-specific guidelines based on the precision values, the contextual content generation system fine-tunes the content generation machine learning model utilizing labeled examples of historical digital content items. In some cases, the contextual content generation system provides relevant input/output pairs to the content generation machine learning model to fine-tune one or more adapter neural networks. For example, the content generation machine learning model utilizes the input/output pairs to train and integrate individual adapter neural networks corresponding to specific key elements with the content generation machine learning model while maintaining the original weights of the content generation machine learning model. In this way, the content generation machine learning model is tailored to a wide variety of key elements utilizing relatively little additional data and computational resources.

In one or more embodiments, the contextual content generation system refines the content generation machine learning model utilizing reinforcement learning in response to the fine-tuned model(s) generating digital content that does not adhere to the context-specific guidelines. In some cases, the contextual content generation system utilizes a proxy reward function to learn an optimal policy for generating content by maximizing a cumulative reward. In some cases, the contextual content generation system utilizes active user device feedback (and/or human feedback) to adapt and produce digital content items based on cumulative rewards. For example, the contextual content generation system utilizes a gradient of a reward function with respect to the model parameters to make iterative incremental adjustments to the contextual content generation system to increase the cumulative reward.

As mentioned, in one or more embodiments, the contextual content generation system evaluates whether the generated digital content items adhere to the context-specific guidelines of the digital guideline document. In some cases, the contextual content generation system utilizes a feedback loop to train the content generation machine learning model via a fine-tuning process and/or a reinforcement learning approach. For example, the contextual content generation system utilizes classifiers to evaluate the digital content items adherence to the context-specific guidelines based on the individual key elements. To illustrate, the contextual content generation system utilizes classifiers to train the content generation machine learning model using a reward model based on the classifiers to provide adherence scores for the generated digital content items based on the key elements. In some cases, the contextual content generation system utilizes a scoring model based on user feedback for the generated digital content items with varying temperature settings (e.g., to simulate different user preferences) and varying user device personas (e.g., tech savvy, content creator, linguistic professor) to further train the model(s). In some cases, the contextual content generation system utilizes a machine learning model (e.g., a large language model) to provide adherence scores for the generated digital content items based on the context and content of the generated digital content items in relation to the key elements.

In contrast to the disclosed systems, prior content generation systems have a number of technical shortcomings with regard to flexibility, accuracy, and computational efficiency when generating digital content items. As one example, many conventional response generation systems are rigid, in part because they are trained on broad, non-specific data sets. This lack of specialization hinders the ability of conventional response generation systems to create digital content items that comply with specific contextual directives. Consequently, without the ability to apply context-specific guidelines, conventional systems provide nonspecific digital content that lacks contextual relevance or a clear adherence to a particular context. To illustrate, many prior systems rigidly lack the ability to fine-tune their output to align with the nuances of context-specific guidelines and/or organizational design requirements without significant modification (e.g., via numerous user inputs or many iterative modifications to digital content). Indeed, in the absence of a specialized training tailored to the context-specific guidelines, such conventional systems often produce digital content items that inconsistently reflect the intended guidelines and fail to maintain a cohesive representation across related digital content items.

Relatedly, many conventional systems rely on a manual and inflexible prompt engineering process, that requires human ingenuity to design prompts that will lead to the desired output. These conventional systems utilize a trial-and-error approach, requiring adjustments based on the effectiveness of the output. The labor-intensive nature of this trial-and-error approach limits the scalability of conventional systems, particularly for large organizations with varied requirements and for processes accessible only via computer interfaces (e.g., application programming interfaces). With these conventional systems, tailoring individual prompts for different contexts becomes impractical or impossible, and without extensive datasets to guide them, these conventional systems often fail to grasp the subtleties needed for context-specific digital content creation.

In addition to inflexibility, many conventional systems are also prone to inaccuracies. Specifically, without a contextual understanding of context-specific guidelines, conventional systems frequently struggle to generate accurate digital content that aligns with a design strategy based on the context-specific guidelines. Indeed, conventional systems, by relying on overgeneralized training on generic data, often struggle to encompass the context and specific aspects of context-specific guidelines (e.g., with incorrect styling, tone, coloring, or other requirements). Such inaccuracies are exacerbated by the inherent diversity and complexity of digital content options, which vary widely in form, style, and substance. Without employing a contextual evaluation of the generated content and utilizing specialized context-specific guideline training, many conventional systems produce content that is not only inaccurate but also non-compliant with the intended design strategy and guidelines.

Conventional systems also have a number of technical shortcomings with regard to computational efficiency when providing digital content items aligned with context-specific guidelines. For example, the learning algorithms of many conventional systems are inefficient because they require more computational power to process excessive amounts of data when generating digital content items. In particular, conventional systems often need to provide an excess of follow-up digital content items to correct for inaccuracies of the initial digital content. This process not only increases the computational burden, but also squanders computational resources that would otherwise be conserved. Relatedly, conventional systems that are not optimized based on contextual data operate with lower efficiency and consume more computational power during training and inference based on their reliance on extremely large and generic data corpuses.

As suggested above, embodiments of the contextual content generation system provide a variety of advantages over conventional response generation systems. Indeed, in some embodiments, the contextual content generation system demonstrates more flexibility, accuracy, and efficiency when training and deploying machine learning models to generate digital content items that adhere to context-specific guidelines. For instance, the contextual content generation system improves operational flexibility when generating digital content items. In contrast to conventional systems that apply a one-size-fits-all approach and omit the particular nuances and details of the context-specific guidelines, embodiments of the contextual content generation system generate digital content items that adhere to the context-specific guidelines by incorporating the context-specific guidelines in prompt augmentation. In addition, by incorporating adapter neural networks in model fine-tuning processes, the contextual content generation system provides additional flexibility by generating content tailored to context-specific guidelines without losing the general knowledge the machine learning models have already learned.

Furthermore, in some embodiments, the contextual content generation system is not limited to one approach and utilizes a performance metric to select from among various fine-tuning approaches and train machine learning models to generate digital content items. For example, by utilizing a specific combination of fine-tuning processes, the contextual content generation system is trained to provide contextual answers with enhanced contextual relevance in line with the context-specific guidelines. Indeed, the contextual content generation system adaptably employs one or more machine learning models, together with contextual sensitivity and fine-tuning, to generate digital content that adheres to context-specific guidelines. In particular, the contextual content generation system ensures that the generated digital content items provide digital content that reflects the image, values, standards, and personality of an entity as indicated by the context-specific guidelines.

Furthermore, in one or more embodiments, the contextual content generation system provides improved accuracy. For example, the contextual content generation system adheres to context-specific guidelines better than conventional systems, thereby more accurately fulfilling requests to generate digital content items based on digital guideline requirements. For example, unlike many conventional systems that lack specialized knowledge of the context-specific guidelines, embodiments of the contextual content generation system generate precise and detailed information (e.g., key elements) for creating digital content items associated with the context-specific guidelines. Indeed, by using a digital guideline retrieval machine learning model to extract key elements from a digital guideline document including the context-specific guidelines, embodiments of the contextual content generation system integrate essential elements from the digital guidelines, resulting in digital content items that are consistent with the guidelines.

Furthermore, by utilizing a tiered fine-tuning process, the contextual content generation system trains the machine learning models to more accurately generate the digital content items based on the context-specific guidelines. For example, the contextual content generation system utilizes one or more machine learning models based on an evaluation of whether a digital content item adheres to the context-specific guidelines. Through this process, the contextual content generation system utilizes increasingly tailors machine learning models to match the intended context-specific guidelines, leading to more precise content generation. Using this tiered contextual content generation, the contextual content generation system provides a step-by-step enhancement and fine-tunes the digital content items at multiple levels, ensuring higher accuracy and relevance in the digital content items it generates.

In addition, embodiments of the contextual content generation system provide improved computational efficiency. For example, unlike conventional systems that repeatedly process generic data for different requests, embodiments of the contextual content generation system more efficiently retrieve and process relevant contextual information, avoiding the computational overhead of sifting through large volumes of irrelevant data. For example, unlike conventional systems that need to process a larger number of follow-up requests to clarify or elaborate upon an inadequate initial response, the contextual content generation system utilizes the key elements (determined via a digital guideline retrieval machine learning model) to interpret requests more accurately on the initial attempt and eliminates (or reduces) additional content generation operations, removing the computational load required for additional clarifying requests.

Furthermore, embodiments of the contextual content generation system are efficiently fine-tuned through the incorporation of adapter neural networks to generate digital content items related to particular key elements. For example, by utilizing adapter neural networks, the contextual content generation system reduces the need to retrain the machine learning models on new data. In particular, by fine-tuning the adapter neural networks, the contextual content generation system trains the machine learning models with less data and in less time. As a result, embodiments of the contextual content generation system provide a marked reduction in the computational resources required-such as processing time and memory allocation-leading to more conservative use of hardware resources.

As illustrated by the foregoing discussion, the present disclosure utilizes a variety of terms to describe features and benefits of the digital document review system. Additional detail is hereafter provided regarding the meaning of these terms as used in this disclosure.

As used herein, the term “digital content item” (or simply “digital content”) refers to a digital object or a digital file that includes information interpretable by a computing device (e.g., a client device) to present information to a user. For example, a digital content item includes a file or a folder such as a digital text file, a digital image file, a digital audio file, a webpage, a website, a digital video file, a web file, a link, a digital document file, or some other type of file or digital object. Furthermore, in some embodiments, a digital content item has a particular file type or file format, which differs for different types of digital content items (e.g., digital documents, digital images, digital videos, or digital audio files). In some cases, a digital content item includes a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. In some embodiments, a digital content item includes application-specific content that is siloed to a particular computer application but is not necessarily accessible via a file system or via a network connection. In one or more embodiments, a digital content item is editable or otherwise modifiable and/or sharable from one user account (or client device) to another. In some cases, a digital content item is modifiable by multiple user accounts (or client devices) simultaneously and/or at different times.

Furthermore, as used herein, the term “context-specific guidelines” refers to guidelines pertaining to various contexts, entities, domains, or branding. In particular, a context-specific guideline refers to a set of instructions and/or recommendations tailored to particular situations, environments, or platforms where messaging and/or a visual identity will be applied. For example, context-specific guidelines provide direction on how to adapt elements such as logo usage, color schemes, typography, and tone of voice to ensure consistency and coherence across various contexts.

Relatedly, as used herein, the term “digital guideline document” refers to a digital document that contains the context-specific guidelines pertaining to various contexts, entities, domains, or branding. For example, the digital guideline document includes digital documents, websites, PDFs, word documents, digital images, and/or text files. To illustrate, a digital guideline document includes a company website that hosts a description of brand guidelines such as pages that detail logo usage, color schemes, typography, imagery, voice, and tone that an entity adopts.

Furthermore, as used herein, the term “key elements” refer to representations of context-specific guidelines extracted from a digital guideline document. In particular, key elements include concise representations of context-specific guidelines for digital content based on words, phrases, or keywords obtained from the digital guideline document. To illustrate, key elements include “Innovative and Modern,” indicating content that aligns with conventional or outdated approaches or innovative and modern thinking, and “Engaging,” indicating digital content that captures and retains user interest.

In addition, as used herein, the term “augmented prompt” refers to an enhanced prompt or instruction for a machine learning model. In particular, the augmented prompt includes content from a prompt (e.g., extracted text) that is augmented with indications of key elements based on the context-specific guidelines. In some cases, the augmented prompt incorporates historical digital content items, which serve as in-context examples. In some cases, the augmented prompt incorporates additional characteristics such as target audience demographics, key performance indicators, guidelines, rules, parameters, and other relevant metrics.

Further, as used herein, the term “large language model” refers to a machine learning model trained to perform computer tasks to generate and/or identify content items in response to trigger events (e.g., user interactions, such as text queries and button selections). In particular, a large language model is a neural network (e.g., a deep neural network) with parameters trained on large quantities of data (e.g., unlabeled text) using a particular learning technique (e.g., self-supervised learning). For example, a large language model includes parameters trained to generate model outputs (e.g., content items, summaries, or query responses) and/or to identify content items based on various contextual data, including graph information from a knowledge graph and/or historical user account behavior.

Relatedly as used herein, the term “machine learning model” includes or refers to a computer algorithm or a collection of computer algorithms that automatically improve for a particular task through iterative outputs or predictions based on the use of data. For example, a machine learning model utilizes one or more learning techniques to improve accuracy and/or effectiveness. Example machine learning models include various types of neural networks, decision trees, support vector machines, linear regression models, and Bayesian networks. In some embodiments, the morphing interface system utilizes a large language machine-learning model in the form of a neural network.

Along these lines, the term “neural network” includes or refers to a machine learning model that is trained and/or tuned based on inputs to determine digital content items, key elements, or approximate unknown functions. For example, a neural network includes a model of interconnected artificial neurons (e.g., organized in layers) that communicate and learn to approximate complex functions and generate outputs (e.g., content items or smart topic outputs) based on a plurality of inputs provided to the neural network. In some cases, a neural network refers to an algorithm (or set of algorithms) that implements deep learning techniques to model high-level abstractions in data. In certain embodiments, a neural network includes various layers, such as an input layer, one or more hidden layers, and an output layer that each perform tasks for processing data. For example, a neural network includes a deep neural network, a convolutional neural network, a transformer neural network, a recurrent neural network (e.g., an LSTM), a graph neural network, or a generative adversarial neural network. Upon training, in some instances, a neural network becomes a large language model.

Furthermore, as used herein, the term “digital guideline retrieval machine learning model” refers to a model (e.g., a neural network), a collection of models, a large language model, or a machine learning model trained to perform computer tasks to generate or identify content items in response to trigger events (e.g., user interactions, such as prompts and button selections). In particular a digital guideline retrieval machine learning model includes a model for parsing a digital guideline document to generate key elements comprising context-specific guidelines for digital content based on words, phrases, or keywords in the digital guideline document.

Furthermore, as used herein, the term “digital guideline retrieval machine learning model” refers to a model (e.g., a neural network), a collection of models, a large language model, or a machine learning model trained to perform computer tasks to generate or identify content items in response to trigger events. For example, the content generation machine learning model includes a large language model or a machine learning model such as a neural network trained to generate digital content and/or digital content items corresponding to the context-specific guidelines. In particular, the content generation machine learning model generates digital content that adheres to the context-specific guidelines based on a combination of prompts, model fine-tuning and model training.

Additionally, as used herein, the term “adapter neural network” refers to a module, or a collection of neural networks, inserted between the layers of a model. In particular, the adapter neural network is a smaller, task-specific module (e.g., neural network) that is added to a large, pre-trained model to perform one or more tasks. For example, the adapter neural network includes its own layers, weights, and activations and is trained to fine-tune a model on a new task and/or domain based on specific requirements without extensive retraining from scratch. To illustrate, the adapter neural network is inserted between layers of the content generation machine learning model to adapt to a particular task and/or entity without modifying the original weights of the content generation machine learning model.

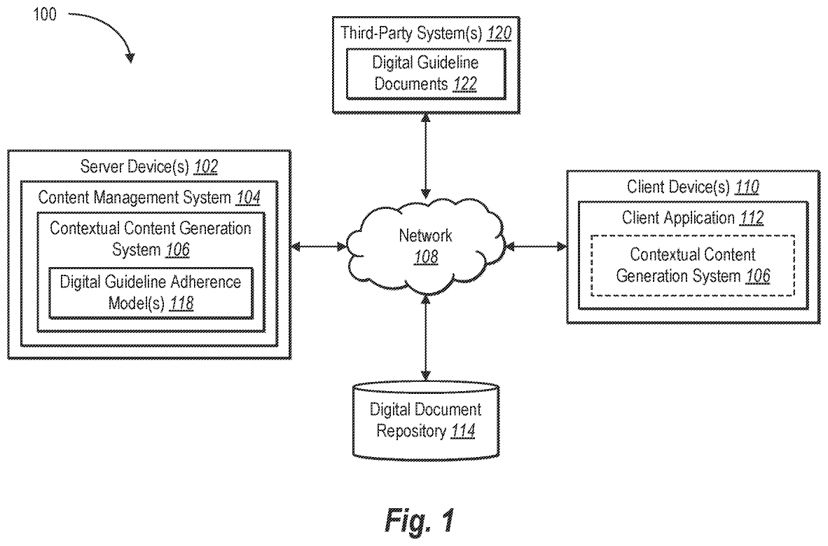

Additional detail regarding the contextual content generation system will now be provided with reference to the figures. For example, FIG. 1 illustrates a schematic diagram of an exemplary system environment (“environment”) 100 in which a contextual content generation system 106 operates. As illustrated in FIG. 1, the environment 100 includes server device(s) 102, a network 108, and client device(s) 110.

Although the environment 100 of FIG. 1 is depicted as having a particular number of components, the environment 100 is capable of having any number of additional or alternative components (e.g., any number of servers, client devices, or other components in communication with the contextual content generation system 106 via the network 108). Similarly, although FIG. 1 illustrates a particular arrangement of the server device(s) 102, the network 108, client device(s) 110, digital document repository 114, and third-party system(s) 120, various additional arrangements are possible.

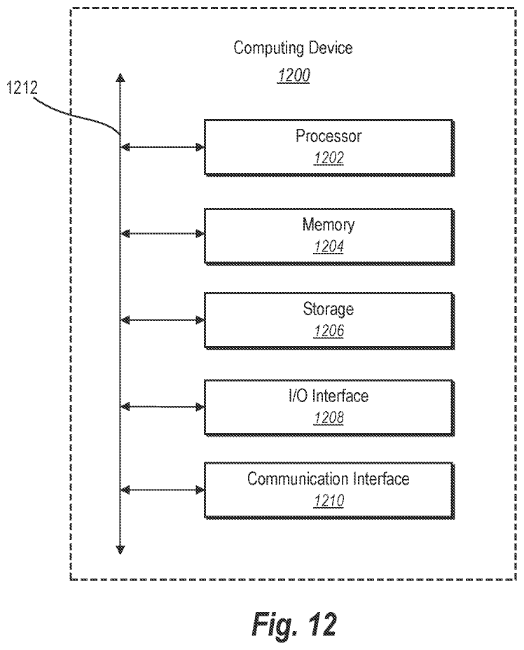

The server device(s) 102, the network 108, client device(s) 110, and third-party system(s) 120, are communicatively coupled with each other either directly or indirectly (e.g., through the network 108 discussed in greater detail below in relation to FIG. 12). Moreover, the server device(s) 102, client device(s) 110, and third-party system(s) 120 include one of a variety of computing devices (including one or more computing devices as discussed in greater detail with relation to FIG. 12).

As illustrated in FIG. 1, the environment 100 includes the digital content management system 104. The digital content management system 104 generates, tracks, stores, processes, receives, and transmits electronic data, including digital content, digital content items, digital guideline documents, and key elements. For example, the digital content management system 104 receives or monitors interactions across the client device(s) 110. In some embodiments, the digital content management system 104 transmits content to the client device(s) 110 to cause the client device(s) 110 to display content associated with contextual queries. For example, the digital content management system 104 receives contextual queries and provides contextual responses to client device(s) 110 corresponding to system need (e.g., provide a request for display via client application(s) 112).

Additionally, the digital content management system 104 includes all, or a portion of, the contextual content generation system 106. For example, the contextual content generation system 106 operates on the server device(s) 102 to access digital content (including digital guideline documents, websites, PDFs, word processing documents, digital images, text files), determine digital content changes, and provide notification of content changes to the client device(s) 110. In one or more embodiments, via the server device(s) 102, the contextual content generation system 106 generates and displays digital content items in connection with context-specific guidelines based on the use of a digital guideline retrieval machine learning model and a content generation machine learning model. Example components of the contextual content generation system 106 will be described below with regard to FIG. 12.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 12. Some embodiments of client device(s) 110 are operated by a user to perform a variety of functions via respective client application(s) 112 such as the generation and presentation of digital content items. The client device(s) 110 include one or more applications (e.g., the client application(s) 112) that access, edit, modify, store, and/or provide, for display, digital content. For example, in some embodiments, the client application(s) 112 include a software application and/or the contextual content generation system 106 installed on the client device(s) 110. In other cases, however, the client application(s) 112 include a web browser or other application that accesses a software application hosted on the server device(s) 102.

In some embodiments, the contextual content generation system 106 is implemented in whole, or in part, by the individual elements of the environment 100. Indeed, as shown in FIG. 1, the contextual content generation system 106 is implemented with regard to the server device(s) 102 and/or the client device(s) 110. As shown, the contextual content generation system 106 includes one or more digital guideline adherence model(s) 118 associated with generating digital content items. In particular embodiments, the contextual content generation system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the contextual content generation system 106 on the client device(s) 110 represents and/or provides the same or similar functionality as described herein in connection with the contextual content generation system 106 on the server device(s) 102. In some embodiments, the contextual content generation system 106 on the server device(s) 102 supports the contextual content generation system 106 on the client device(s) 110.

In some embodiments, the contextual content generation system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., selected content items). In response, the contextual content generation system 106 on the server device(s) 102 generates/modifies digital content. The server device(s) 102 provides the digital content to the client device(s) 110.

In some embodiments, the contextual content generation system 106 includes the third-party system(s) 120 and the digital guideline documents 122. To illustrate, in one or more embodiments, the contextual content generation system 106 interacts with content and services hosted on the third-party system(s) 120. To illustrate, in one or more embodiments, the contextual content generation system 106 accesses a web page or computing application supported by the third-party system(s) 120. The third-party system(s) 120 provide input to the contextual content generation system 106 (e.g., requests) and digital guideline documents 122 (e.g., PDFs, word processing documents, digital images, text files). In response, the contextual content generation system 106 generates/modifies digital content including generating digital content items. The contextual content generation system 106 provides the digital content to the third-party system(s) 120.

In one or more embodiments, the client device(s) 110 and the server device(s) 102 work together to implement the contextual content generation system 106. For example, in some embodiments, the server device(s) 102 train one or more machine learning models (e.g., encoders, digital guideline retrieval machine learning models, content generation machine learning models, reward models and/or adapter neural networks), such as neural networks, and provide the one or more trained machine learning models to the client device(s) 110 for implementation. In some embodiments, the server device(s) 102 train one or more models (e.g., neural networks) together with the client device(s) 110.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

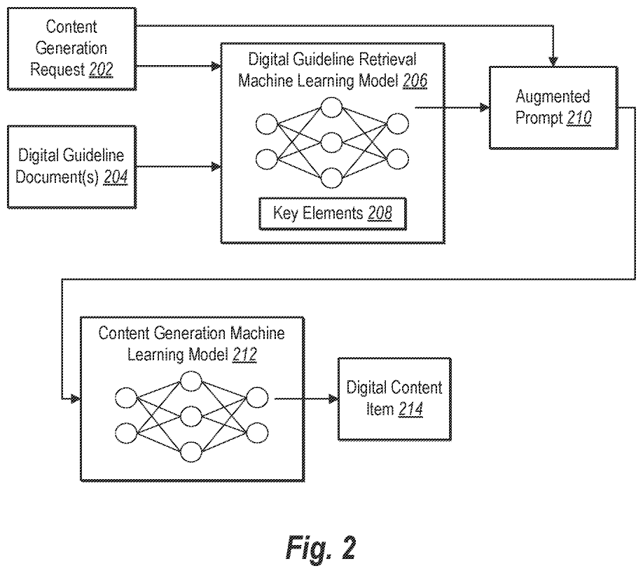

As previously mentioned, in one or more embodiments, the contextual content generation system 106 trains and implements one or more machine learning models (e.g., large language models) to provide digital content items based on context-specific guidelines. In particular, the contextual content generation system 106 utilizes a specific combination of machine learning models to generate one or more digital content items in line with context-specific guidelines. FIG. 2 illustrates an example overview of using a contextual content generation system to generate a digital content item according to context-specific guidelines in accordance with one or more embodiments. Additional detail regarding the various acts of FIG. 2 is provided thereafter with reference to subsequent figures.

As shown, the contextual content generation system 106 receives a content generation request 202 that includes a request to generate digital content based on context-specific guidelines. For example, a content generation request 202 (received from a client device) includes a request to provide digital content based on context-specific guidelines for a consistent portrayal of the image, values, standards, and personality associated with an entity. To illustrate, the content generation request 202 includes requests such as “Generate a headline for the new feature in <Product> where the campaign for landing page https://productinfopage.html is being sent to active <Product> users as a campaign with learning intent,” to request generation of digital content associated with <Product> and based on the context-specific guidelines.

As shown, the contextual content generation system 106 identifies or receives digital guideline document(s) 204. Specifically, the contextual content generation system 106 identifies digital guideline document(s) 204 (e.g., including digital guideline documents, websites, PDFs, word documents, digital images, and/or text files) pertaining to various contexts, entities, domains, or branding. For example, the contextual content generation system 106 obtains digital guideline document(s) 204 that incorporate unstructured text. As an example, a digital guideline document(s) 204 includes a company website that hosts a description of brand guidelines such as pages that detail logo usage, color schemes, typography, imagery, voice, and tone that an entity adopts. As another example, a digital image includes visual representation of a guideline aesthetic and visual guidelines such as examples of correct logo usage, photography style, color palettes, and the overall look and feel the guidelines aim to achieve. As another example, word processing documents, PDFs, and text files include written guidelines that specify tone of voice, writing style, acceptable language, and branding elements. In particular, the contextual content generation system 106 utilizes the digital guideline document(s) 204 from any applicable source in a schema free approach. In such a way, by eliminating the need to conform to a pre-defined schema, the contextual content generation system 106 provides greater flexibility in generation of digital content from the user device.

As also shown, the contextual content generation system 106 utilizes a digital guideline retrieval machine learning model 206 to extract key elements 208 from the digital guideline document(s) 204. In particular, the contextual content generation system 106 parses the digital guideline document(s) 204 to generate key elements comprising context-specific guidelines for digital content based on words, phrases, or keywords from the digital guideline document(s) 204. In some cases, the contextual content generation system 106 generates a list of summarized bullets-point guidelines and/or line items based on digital content from the digital guideline document(s) 204 for objective evaluation of adherence. For example, the contextual content generation system 106 extracts key elements 208 that include “Innovative and Modern” for objective evaluation based on whether the generated digital content aligns with conventional or outdated approaches or innovative and modern thinking. As another example, the contextual content generation system 106 extracts key elements 208 that include “Engaging” for objective evaluation based on whether the generated digital content is effective in capturing and retaining user interest.

As shown in FIG. 2, in some cases, the digital guideline retrieval machine learning model 206 is a machine learning model (e.g., a neural network) or a collection of machine learning models for generating key elements 208 from the content generation request 202. In some embodiments, the digital guideline retrieval machine learning model 206 and/or the content generation machine learning model 212 include a large language model or refer to a machine learning model trained to perform computer tasks to generate or identify content items in response to trigger events (e.g., user interactions, such prompts and button selections). In some cases, the digital guideline retrieval machine learning model 206 includes parameters trained to generate model outputs (e.g., digital content items, key elements, or reward values) and/or to digital content based on various contextual data, including historical digital content.

As further shown in FIG. 2, the contextual content generation system 106 generates an augmented prompt 210. In particular the contextual content generation system 106 generates an augmented prompt 210 by enhancing or augmenting the content generation request 202 with indications of the key elements 208 generated by the digital guideline retrieval machine learning model 206. In addition, in some embodiments, the contextual content generation system 106 enhances or augments the content generation request 202 with historical digital content items (e.g., in-context examples), content characteristics (e.g., target audience, key performance indicators), and relevant extracted text (e.g., based on the content generation request 202) to generate the augmented prompt 210.

As further shown, the contextual content generation system 106 utilizes a content generation machine learning model 212 to generate one or more of a digital content item 214. As mentioned, the content generation machine learning model 212 includes a large language model or a machine learning model such as a neural network trained to generate digital content and/or digital content items corresponding to the context-specific guidelines. In one or more embodiments, the digital content item 214 includes digital content such as emails, display ads, video ads, multimedia content, blogs, infographics, e-books, podcasts, videos, website content, social media, digital marketing materials, and other digital content. In addition, the digital content item 214 includes a portion of digital content (e.g., a title, summary, image, section) contained within one or more digital content items. In certain embodiments, the contextual content generation system 106 trains and utilizes the digital guideline retrieval machine learning model 206 to generate the digital content item 214 using one or more methods based on a performance metric. In particular, the contextual content generation system 106 generates digital content that adheres to the context-specific guidelines utilizing the content generation machine learning model 212 based on a combination of prompts, model fine-tuning and model training as described in more detail in relation to the subsequent figures.

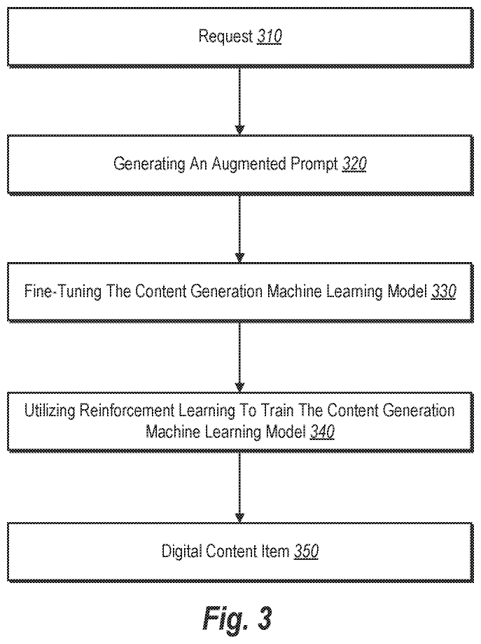

As mentioned, the contextual content generation system 106 utilizes a variety of methods to generate digital content items. For example, the contextual content generation system 106 utilizes a combination of prompts, model fine-tuning, and RLHF (e.g., reinforcement learning and/or user device feedback). As mentioned, the contextual content generation system 106 utilizes machine learning models to generate digital content corresponding to the context-specific guidelines. FIG. 3 illustrates an example of dynamically utilizing one or more machine learning models to generate a digital content item in accordance with one or more embodiments.

As shown in FIG. 3, the contextual content generation system 106 receives a request 310 and utilizes one or more machine learning models (e.g., via step 320, step 330, and/or step 340) to generate a digital content item 350. As shown, the contextual content generation system 106 utilizes methods that include the step 320 of generating an augmented prompt, the step 330 of fine-tuning the content generation machine learning model, and/or the step 340 of utilizing reinforcement learning to train the content generation machine learning model. In conventional systems generating a prompt (e.g., prompt engineering) requires human input to design and adjust parameters or prompt elements used to guide the behavior of machine learning models. In contrast, the contextual content generation system 106 utilizes an automated approach to augment a prompt via a machine learning model (e.g., a large language model) and also select among one or more methods including utilizing the augmented prompt, fine-tuning, and/or the reinforcement learning to generate the digital content item 350.

For example, as shown in FIG. 3, the contextual content generation system 106 enhances efficiency by first performing a step 320 of generating an augmented prompt using machine learning models to generate the digital content item 350 based on the request 310. Based on evaluating the adherence of the digital content item 350 to the context-specific guidelines, the contextual content generation system 106 performs step 330 of fine-tuning the content generation machine learning model to further refine the digital content item 350. Furthermore, in some embodiments, after fine-tuning and based on evaluating the adherence of the digital content item 350 to the context-specific guidelines, the contextual content generation system 106 performs step 340 of utilizing reinforcement learning to train the content generation machine learning model and generate a further refined version of the digital content item 350.

The contextual content generation system 106 determines one or more precision values indicating an adherence of the digital content item to the context-specific guidelines of the digital guideline document based on comparing the digital content item to the key elements extracted from the digital guideline document. Furthermore, the contextual content generation system 106 determines if the one or more precision values are below a threshold value. Based on whether the one or more precision values are below the threshold value, the contextual content generation system 106 modifies the parameters of the content generation machine learning model utilizing model fine-tuning and/or reinforcement learning.

To illustrate, the contextual content generation system 106 determines a performance metric to ascertain the effectiveness of using an augmented prompt, model fine-tuning, and/or reinforcement learning. The performance metric reflects one or more precision values which the contextual content generation system 106 utilizes to select the appropriate technique, or combination thereof, for generating the digital content item. For example, the contextual content generation system 106 determines a precision value such as:

$$( \frac{n umber of times the generated content was context - specific}{total number of generations} ) .$$

To illustrate, the contextual content generation system 106 generates 100 instances of headlines for a campaign and evaluates how often were the headlines were engaging (e.g., satisfy the key element “engaging”). Similarly, the contextual content generation system 106 determines a precision value for each key element of the extracted key elements.

In addition, the contextual content generation system 106 evaluates the precision value against a threshold value. In particular, the contextual content generation system 106 utilizes the threshold value to determine whether to use an augmented prompt, fine-tuning the content generation machine learning model, and/or utilize reinforcement learning (e.g., step 320, step 330, and/or step 340, respectively). For instance, the contextual content generation system 106 generates a digital content item 350 utilizing an augmented prompt and determines a precision value. Further, based on the precision value meeting or exceeding the threshold value (e.g., as configured by the user device), the contextual content generation system 106 determines that the digital content item adheres sufficiently to the context-specific guidelines using the augmented prompt and does not utilize fine-tuning or reinforcement learning. In contrast, based on determining the precision value does not satisfy the threshold value, the contextual content generation system 106 fine-tunes the content generation machine learning model utilizing model-fine tuning and/or reinforcement learning to generate a digital content item that adheres more closely to the context-specific guidelines.

To illustrate, the contextual content generation system 106 provides the itemized brand guideline as part of an augmented prompt. To illustrate, the augmented prompt includes the text “Generate a headline for new feature <Feature> in <Product> where the campaign for landing page http://page.html is being sent to active <Product> users as an information/knowledge sharing campaign—the headline should be engaging.” Based on the augmented prompt, the contextual content generation system 106 determines a precision value reflecting how often the content generation machine learning model generates a headline that is engaging. If the precision value meets or is above the threshold value, then the contextual content generation system 106 determines that the content generation machine learning model satisfactorily generated the required content utilizing the augmented prompt (and does not execute step 330 and/or step 340).

In contrast, if the contextual content generation system 106 determines the precision value is not above the threshold value, the contextual content generation system 106 proceeds to step 330 of fine-tuning the content generation machine learning model. In particular, the contextual content generation system 106 utilizes the fine-tuned content generation machine learning model to generate a digital content item 350. Further, the contextual content generation system 106 determines a precision value reflecting how often the fine-tuned content generation machine learning model generates a headline that is engaging. Further, based on the precision value satisfying the threshold value, the contextual content generation system 106 determines that the fine-tuned content generation machine learning model generated a sufficiently precise digital content item (e.g., a digital content item that adheres sufficiently to the context-specific guidelines) using the fine-tuned content generation machine learning model and does not utilize reinforcement learning (e.g., step 340).

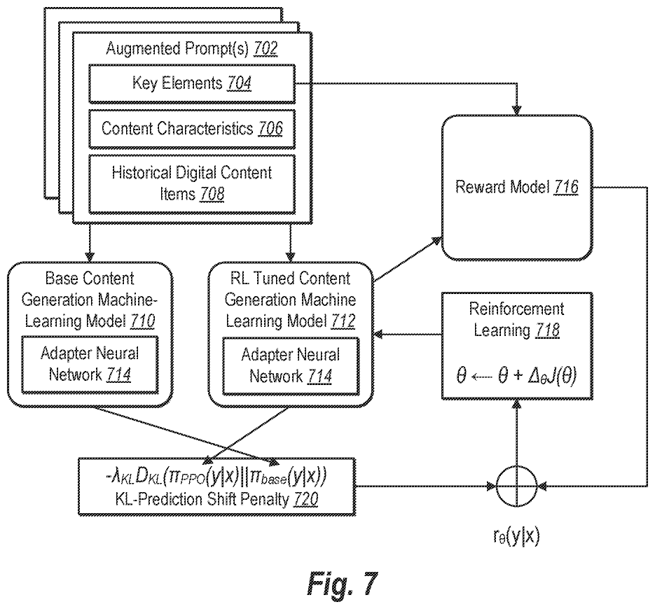

Furthermore, if the contextual content generation system 106 determines the precision value for the fine-tuned content generation machine learning model is not above the threshold value, the contextual content generation system 106 utilizes reinforcement learning to further train the content generation machine learning model. Detail regarding training the content generation machine learning model utilizing reinforcement learning is provided with reference to FIG. 7.

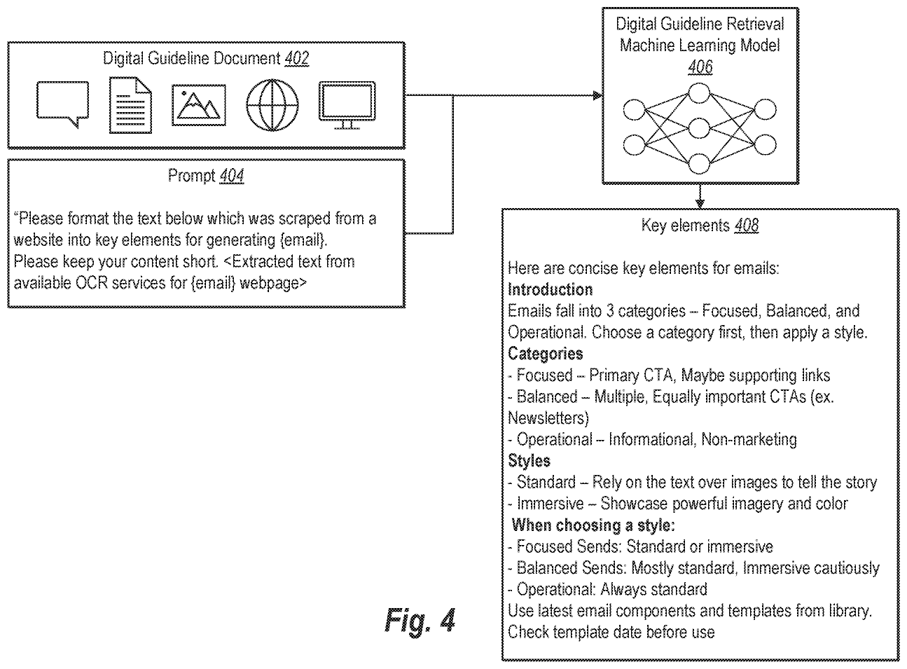

As mentioned, the contextual content generation system 106 trains and utilizes the digital guideline retrieval machine learning model to extract key elements from a digital guideline document. FIG. 4 illustrates an example of utilizing a digital guideline retrieval machine learning model to generate key elements in accordance with one or more embodiments.

As shown in FIG. 4, the contextual content generation system 106 generates key elements 408 based on a digital guideline document 402 and a prompt 404. As mentioned, the contextual content generation system 106 receives or accesses the digital guideline document 402 which includes context-specific guidelines. As mentioned, the context-specific guidelines are documented in a variety of formats and are not limited to a particular format. As an example, context-specific guidelines include unstructured text that outline context-specific guidelines for an entity. To illustrate, the context-specific guidelines include unstructured content identifying a need to “provide content characterized by helpfulness, respectfulness, and honesty.” To further illustrate, the context-specific guidelines include unstructured content that mandates creating “digital content that is engaging, relatable, and emotionally impactful, while avoiding overly formal or clichéd language.”

As further shown, the contextual content generation system 106 generates a prompt 404 to extract key elements 408 from the digital guideline document 402. As shown, the contextual content generation system 106 utilizes a prompt that causes the content guideline retrieval machine learning model 406 to extract guidelines that are specific (e.g., narrowly focused) and concise (e.g., not overly broad). In particular the prompt 404 is an input query or set of instructions provided to the content guideline retrieval machine learning model 406. The prompt 404 is crafted in such a way that leads the content guideline retrieval machine learning model 406 to focus on extracting the most relevant and essential guidelines for digital content creation. Indeed, by providing a prompt 404 crafted to extract specific and concise guidelines, the contextual content generation system 106 prompts the content guideline retrieval machine learning model 406 to generate key elements that are relevant to the particular context-specific guidelines and also avoid unnecessary complexity.

As shown, the contextual content generation system 106 extracts key elements 408 from the digital guideline document 402. As shown, the key elements 408 include a specific and concise description of the context-specific guidelines from the digital guideline document 402. To illustrate, the key elements 408 “Focused—Primary Call to Action (CTA), Maybe supporting links,” “Balanced—Multiple, Equally important CTAs,” and “Operational—Information, Non-marketing”are concise and communicate the essential concepts without extraneous details using minimal language to set the expected tone and purpose. As also shown, the key elements are narrow in scope with a focus on the most important action, thereby avoiding ambiguity or confusion that might arise from multiple or conflicting elements.

Furthermore, in one or more embodiments, the content guideline retrieval machine learning model 406 generates key elements 408 in a structured, concise format as a list of summarized bullet-point guidelines. The key elements 408 are based on the words, phrases, or keywords in the digital guideline document which are capable of being objectively evaluated. For example, the contextual content generation system 106 evaluates the key element of “Focused—Primary CTA, Maybe supporting links” by analyzing the text structure to ensure there is a single prominent CTA. As another example, the contextual content generation system 106 evaluates the key element of “Balanced-Multiple, Equally important CTAs” by analyzing digital content for multiple action phrases and assessing their positioning within the digital content to evaluate whether they appear with equal importance. As another example, the contextual content generation system 106 evaluates the key element of “Operational—information, Non-marketing” by scanning for marketing language and/or promotional phrases and evaluating their presence as a deviation from the guidelines.

In addition to generating the key elements 408, in some embodiments, the contextual content generation system 106 extracts and aligns the generated key elements with traits. For example, the contextual content generation system 106 utilizes a prompt to extract traits from the key elements 408. For example, the contextual content generation system 106 provides a prompt such as: “Extract the positive and negative traits. The traits should be short abstract noun or adjective phrases indicating how the content should be. Split phrases consisting of multiple traits into separate traits. Present it in JSON format.” In this way, the contextual content generation system 106 determines traits associated with the key elements 408.

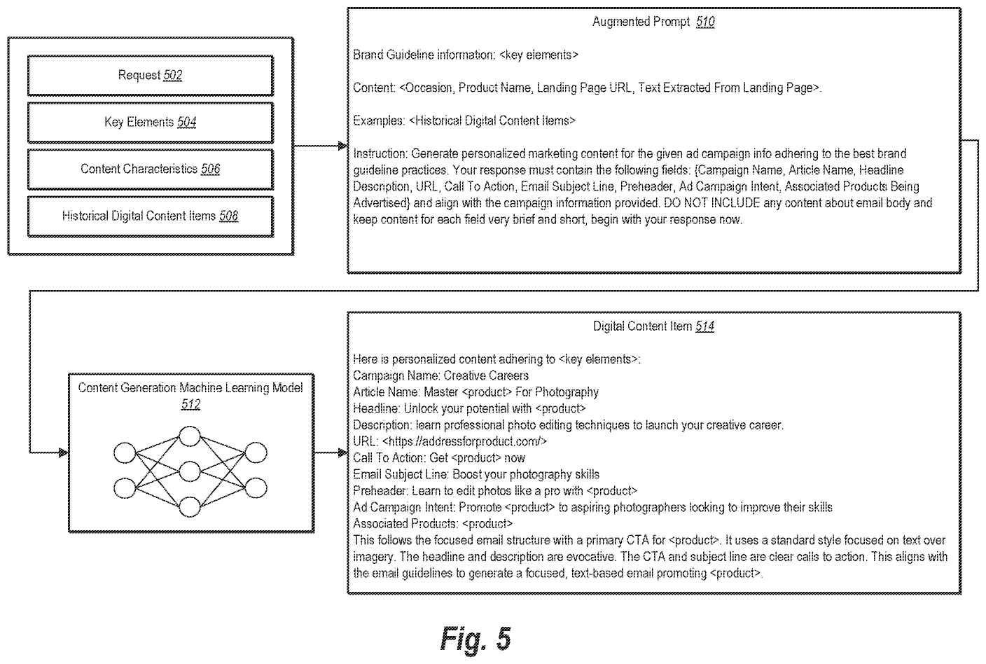

As mentioned, the contextual content generation system 106 generates a digital content item using an augmented prompt that includes examples of historical digital content items, indications of key elements, digital content and content characteristics. FIG. 5 illustrates an example of utilizing a content generation machine learning model to generate a digital content item in accordance with one or more embodiments.

As shown, the contextual content generation system 106 generates an augmented prompt 510 based on a request 502, key elements 504, content characteristics 506, and historical digital content items 508. In particular, the contextual content generation system 106 augments or enhances the request 502 with the key elements 504, the content characteristics 506, and the historical digital content items 508 to generate the augmented prompt 510. For example, the contextual content generation system 106 generates the augmented prompt 510 by including the key elements 504 extracted from the digital guideline document as described in relation to FIG. 4.

In addition, the contextual content generation system 106 enhances the request 502 with the content characteristics 506. Content characteristics 506 include components of a specific content strategy relative to the current digital content. For example, content characteristics 506 define the specific objectives, strategies, and components of a particular campaign. To illustrate, content characteristics 506 are tailored to achieve particular goals within a set timeframe and target specific audience segments within the broader context of the context-specific guidelines. Furthermore, in certain embodiments, the contextual content generation system 106 enhances the request 502 (e.g., an initial prompt from the user device) with historical digital content items 508 corresponding to the context-specific guidelines. To illustrate, the contextual content generation system 106 provides historical digital content items 508 that correspond to historical data from previous campaigns or previously utilized content characteristics. In this way, the contextual content generation system 106 utilizes previously effective or successful digital content items as a reference point. In some cases, the contextual content generation system 106 utilizes historical digital content items 508 of ten or more.

As further shown in FIG. 5, the contextual content generation system 106 provides the augmented prompt 510 to the content generation machine learning model 512 to generate the digital content item 514. In particular, in some embodiments, the contextual content generation system 106 utilizes prompt engineering as described above to generate the augmented prompt 510 which is provided to the content generation machine learning model 512 to generate the digital content item based on context-specific guidelines. As shown in the example of FIG. 5, the digital content item 514 adheres to the key elements 504 by using a standard style focused on text over imagery, using an evocative headline and description, and incorporating a clear call to action.

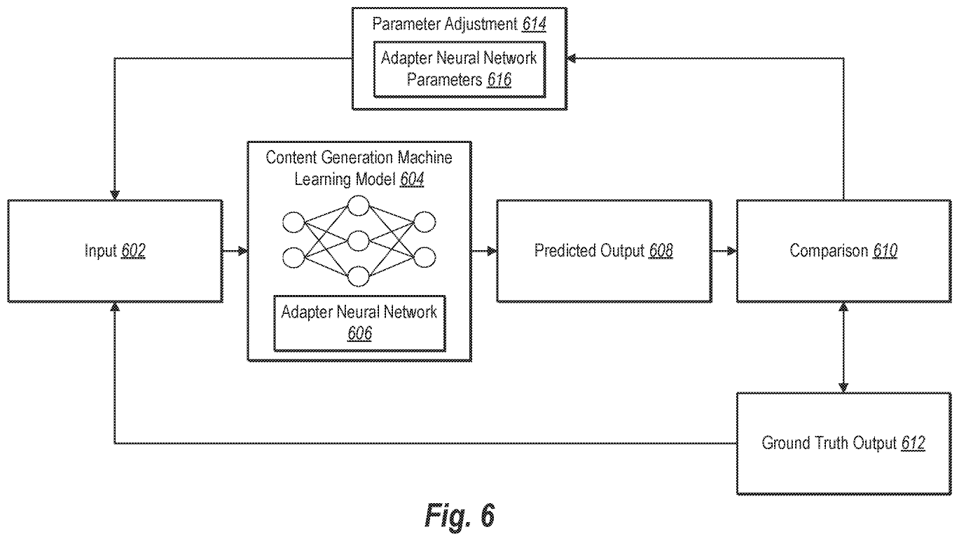

As mentioned, the contextual content generation system 106 selects a content generation method/operation from among prompt engineering, model fine-tuning, and/or additional model training. In particular, in some cases, the contextual content generation system 106 fine-tune the content generation machine learning model in response to determining that prompt engineering alone results in generating content that does not adhere to specific guidelines. FIG. 6 illustrates an example of fine-tuning a content generation machine learning model in accordance with one or more embodiments.

In particular, if the contextual content generation system 106 determines that the digital content item generated by the augmented prompt does not satisfy a threshold precision value for a key element, the contextual content generation system 106 fine-tunes the content generation machine learning model 604 utilizing one or more of an adapter neural network 606. In particular, the contextual content generation system 106 fine-tunes an adapter neural network 606 associated with the content generation machine learning model 604 utilizing labeled examples of historical digital content items corresponding to the context-specific guidelines. For example, for each key element, the contextual content generation system 106 trains and utilizes an adapter neural network 606 inserted between the layers of the content generation machine learning model. By using one or more of the adapter neural network 606, the contextual content generation system 106 significantly reduces computational costs and resources compared to conventional systems to achieve similar levels of training.

To illustrate, as shown in FIG. 6, the contextual content generation system 106 provides input 602 (e.g., a sample digital content item) and the ground truth output 612 (e.g., a digital content item that adheres to the context-specific guidelines). In some embodiments, the contextual content generation system 106 utilizes the content generation machine learning model 604 and adapter neural network 606 to generate a predicted output 608 from the input 602. Specifically, the content generation machine learning model 604 and the adapter neural network 606 generate the predicted output 608 according to their internal parameters.

As part of training the adapter neural network 606, the contextual content generation system 106 performs a comparison 610. Specifically, the contextual content generation system 106 compares the predicted output 608 with the ground truth output 612. In some cases, the contextual content generation system 106 performs the comparison 610 using a loss function such as a mean squared error loss function or a cross entropy loss function to determine an error or a measure of loss associated with the adapter neural network (or between the predicted output 608 and the ground truth output 612).

In one or more embodiments, the contextual content generation system 106 further performs a parameter adjustment 614. Based on the comparison 610, the contextual content generation system 106 modifies the adapter neural network parameters 616. For example, contextual content generation system 106 modifies parameters of the adapter neural network 606 to reduce a measure of error or a loss associated with the content generation machine learning model 604 and the adapter neural network 606. The contextual content generation system 106 further repeats the process illustrated in FIG. 6 for many iterations or epochs until the content generation machine learning model 604 and the adapter neural network 606 satisfy a threshold measure of loss. For each iteration, the contextual content generation system 106 generates new predictions from new sample data, performs a comparison, and modifies parameters (e.g., via back propagation) to improve predictions for subsequent iterations.

In one or more embodiments, the contextual content generation system 106 utilizes small adapter neural networks that are much smaller in size (e.g., number of parameters) than the content generation machine learning model 604 (e.g., 1-2% of the size). In this way the contextual content generation system 106 enables scaling the content generation machine learning model 604 to generate different digital content items (e.g., subject line, preheader) based on different tasks and for different entities with the same underlying large language model.

As an illustrative example, the contextual content generation system 106 trains the adapter neural network 606 with fewer than 100 examples for email catch phrase generation. In some embodiments, the contextual content generation system 106 utilizes a fixed template in the training data (e.g., including Product, Description, and Task). For example, the contextual content generation system 106 provides an augmented prompt to the adapter neural network 606 that includes a Product of “Cashmere Sweater Hoodie,” a Description of “Luxurious and timeless, this cashmere sweater will be the one you reach for season after season, thanks to a special yarn spun for exceptional softness and durability,” and a Task (e.g., email catch phrase) of “luxurious and timeless”/“sustainable and soft”/“silky and warm.” In this way, the contextual content generation system 106 trains the adapter neural network based on fixed template for one or more tasks and/or one or more entities utilizing the same content generation machine learning model.

As mentioned, the contextual content generation system 106 selects a content generation method/operation from among prompt engineering, model fine-tuning, and/or additional model training. In particular, in some cases, the contextual content generation system 106 utilizes reinforcement learning to train the content generation machine learning model (e.g., utilizing reinforcement learning) in response to determining that prompt engineering and/or model fine-tuning results in content that does not adhere to specific guidelines. FIG. 7 illustrates an example of utilizing reinforcement learning with a reward model in accordance with one or more embodiments.

As shown, the contextual content generation system 106 generates the augmented prompt 702 including key elements 704, content characteristics 706, and historical digital content items 708. As further shown, the contextual content generation system 106 provides the augmented prompt 702 to a base content generation machine learning model 710 (e.g., an instruction-tuned model), RL tuned content generation machine learning model 712, and reward model 716. In one or more embodiments, the base content generation machine learning model 710 includes the fine-tuned model as described in relation to FIG. 6. In alternative embodiments, the base content generation machine-learning model 710 includes a model prior to any fine-tuning operations. Accordingly, in various embodiments, the contextual content generation system 106 performs reinforcement learning on a fine-tuned machine-learning model or a machine-learning model that has not been fine-tuned, depending on content adherence to specific guidelines.

In one or more embodiments, the contextual content generation system 106 trains the base content generation machine learning model 710 with reinforcement learning to generate the RL tuned content generation machine learning model 712. In particular, the contextual content generation system 106 utilizes reinforcement learning to update the parameters θ of the RL tuned content generation machine learning model 712 (e.g., the parameters of the adapter neural network 714). The contextual content generation system 106 uses reinforcement learning 718 which incorporates Proximal Policy Optimization (PPO) based on the gradient of the reward function J(θ) with respect to the parameters θ of the RL tuned content generation machine learning model 712. In particular, the contextual content generation system 106 incorporates PPO as reinforcement learning 718 where feedback is provided in the form of rewards. To illustrate, PPO takes the state of the environment as input (e.g., parameters θ (weights and biases)) and utilizes the gradient of an objective function (e.g., direction and magnitude of change Δ_{θ}J(θ)) to update the parameters based on an update rule (e.g., θ←θ+Δ_{θ}J(θ)). By using PPO as illustrated, the contextual content generation system 106 iteratively makes incremental adjustments to increase the cumulative reward.

As further shown, the contextual content generation system 106 utilizes a reward model 716. The reward model 716 is a model trained on consumer-content interaction data (e.g., click-ability of generated digital content items). To illustrate, for a specific digital content item, and the contextual content generation system 106 provides a higher reward based on higher click-ability (e.g., where the digital content item is clicked more than other digital content items). The reward model 716 includes parameters learned based on feedback from user devices indicating precision values. The reward model 716 evaluates the generated digital content item from the RL tuned content generation machine learning model 712 and provides a reward value that indicates the adherence of the digital content item to the context-specific guidelines.

As also shown, the contextual content generation system 106 utilizes a KL-prediction divergence penalty 720 to control the rate of change to the RL tuned content generation machine learning model 712. In particular, the contextual content generation system 106 utilizes the expression −λ_{KL}D_{KL}(πPPO(y|x)∥πbase(y|x) to generate a divergence penalty. This expression is used to prevent the policy (π_{PPO}) from deviating too much from the original policy (π_{base}). The λ_{KL} is a coefficient that controls the strength of this penalty. By using λ_{KL}, the contextual content generation system 106 incorporates an objective function to ensure that while the RL tuned content generation machine learning model 712 learns from new data, the RL tuned content generation machine learning model 712 does not stray too far from the base content generation machine learning model 710 (e.g., maintaining a balance between exploration and exploitation). By using the method shown in FIG. 7, contextual content generation system 106 uses both fine-tuning and reinforcement learning to generate content that aligns with the context-specific guidelines.

As a qualitative example, once trained, the RL tuned content generation machine learning model 712 crafts content of superior quality, relevance, and persuasiveness when juxtaposed with both ablations and the base model. The table below provides qualitative metrics for the RL tuned content generation machine learning model 712 compared to the base (untuned) model and an ablation model (target info) when quantized to use 4-bit precision for their parameters. In particular, the RL tuned content generation machine learning model 712 is evaluated based on general text quality (e.g., overall quality of the generated text in terms of coherence, fluency, and grammatical correctness), field content quality (e.g., relevance and accuracy of the generated content in relation to key elements), and brand adherence (e.g., how well the generated content adheres to the context-specific guidelines.

| | 4 bit quantized machine learning model | | | |
|---|---|---|---|---|
| | Content | RL tuned content | | |
| | generation | generation | | Non- |
| | machine learning | machine learning | Ablation | quantized |
| | model | model | (target info) | LLM |
| General Text Quality | 3.805 | 3.891 | 3.783 | 4.338 |
| Field Content Quality | 3.852 | 3.906 | 3.803 | 4.115 |
| Brand Adherence | 2.664 | 2.676 | 2.713 | 2.582 |

As shown in the table, the RL tuned content generation machine learning model 712 consistently outperforms the base and ablation models across these metrics. As also shown, the RL tuned content generation machine learning model 712 rivals a sample non-quantized large language model (with a parameter count 25 times greater) trained on a diverse and extensive dataset (spanning over a terabyte of text data) in terms of text generation quality.

In another qualitative example, the contextual content generation system 106 utilizing a reward model outperforms the contextual content generation system 106 using an augmented prompt. In particular, when the reward model 716 is modeled to quantify adherence to brand guidelines for generating email body copy based on blog data, the average reward for using an augmented prompt (with the context-specific guidelines included) vs prompting a RL tuned content generation machine learning model 712 as described in relation to FIG. 7 (without including the context-specific guidelines) is 0.646 vs 1.785. In this case, the reward model 716 was based on a binary brand adherence validation classifier that emits a logit value. Furthermore, the RL tuned content generation machine learning model 712 had a win rate of 99.6% over the content generation machine learning model with an augmented prompt, demonstrating the RL tuned content generation machine learning model 712 provides significant improvements in context-specific guideline adherence.

As another quantitative example, the RL tuned content generation machine learning model 712 provides a notable improvement in the computed adherence (e.g., precision values) of the contextual content generation system 106 to context-specific guidelines. In the table below, a larger reward provided by reward model 716 is associated with increased engagement and originality in the content, along with a more human and enthusiastic tone, in addition to being more direct and less vague. The RL tuned content generation machine learning model 712 consistent generates a larger reward value as follows:

| Content generation machine | RL tuned content generation machine |
|---|---|
| learning model | learning model |
| Unlock the full potential of <Company> | Discover the luxury of <Company> digital |
| luxury products with our cutting-edge | storefront, now powered by <Company>. |
| technology and innovative e-commerce | Explore 1,500+ products showcasing the |
| solutions. Experience the premium quality | brand's rich heritage and craftsmanship, |
| of service and rich product storytelling | elevated by stunning imagery and |
| that mirrors the charm of our in-store | personalized storytelling. Unlock the |
| experiences. Upgrade your online | premium online shopping experience, |
| shopping experience today and discover | driving sales, loyalty, and high-spend |
| the <Company> difference. | purchases. Treat yourself to the best of |
| Reward: 0.5108 | <Company>, now just a click away. |
| | Reward: 1.0986 |
| Unlock your full creative potential and | Transform your creative process with |
| join the #CreateWaves movement with | <Product>, the industry-leading design |
| <Product>! Discover how <Name> is | software. Join the #CreateWaves movement |
| using her art to protect the ocean and | and inspire ocean conservation with your art. |
| inspire action. Learn more and get started | Learn from <Name> latest work and how |
| today! | communities around the world can come |
| Reward: 0.9382 | together to protect the ocean. Take action |
| | today and create a better future for our planet. |
| | Reward: 1.9459 |
| “Unlock your full potential with | Transform your document workflows with |
| <Product>! Say goodbye to clunky PDFs | <Product> browser extension! Now, open |
| and hello to seamless document editing | and edit PDFs directly in your web browser |
| directly in your web browser. Try it now | for fast, nimble document updates. Say |
| and work faster, smarter, and more | goodbye to clunky desktop apps and hello to |
| efficiently than ever before! #PDFEditor | seamless collaboration. Try it now and |
| #WebBrowser #Productivity” | unlock endless possibilities! |
| Reward: 0.5108 | Reward 1.9459 |

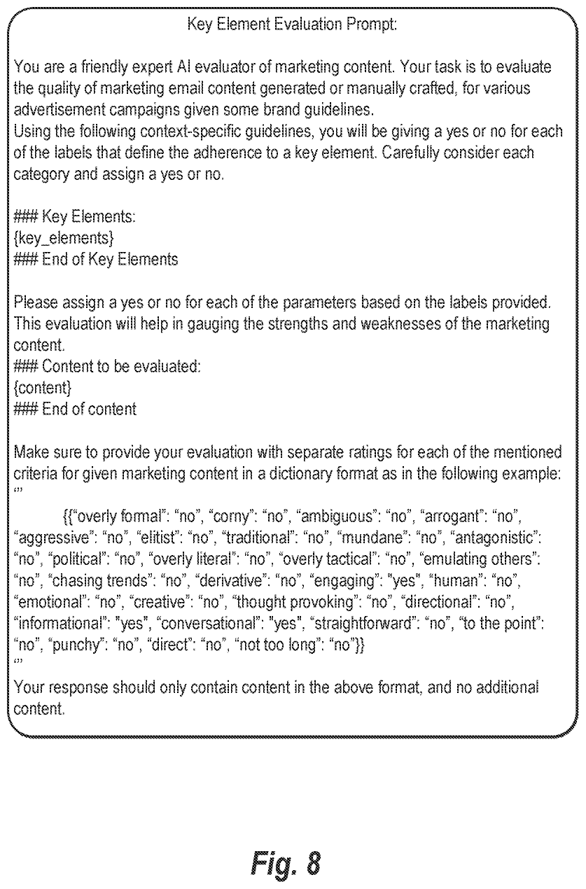

As mentioned, the contextual content generation system 106 evaluates whether the content of the digital content items adheres to the context-specific guidelines. Indeed, based on whether the content of the digital content items adheres to the context-specific guidelines, the contextual content generation system 106 selects a content generation method/operation from among prompt engineering and/or updating the content generation machine learning model (e.g., utilizing one or more of the methods described in relation to FIG. 2 and FIGS. 6-7). Relatedly, FIG. 8 illustrates an example of the contextual content generation system performing a key element evaluation based on the context-specific guidelines in accordance with one or more embodiments.

As mentioned, the contextual content generation system 106 extracts key elements into concise bullet-points that the contextual content generation system 106 evaluates individually to determine if the digital content items adhere to the key element. In some embodiments, the contextual content generation system 106 builds classifiers for each of the key elements to evaluate the digital content items. For example, the contextual content generation system 106 utilizes foundational large language models trained using few-shot learning to serve as classifiers. To illustrate, the contextual content generation system 106 provides in-context examples in combination with digital content items to train the classifiers. As shown in FIG. 8, in some embodiments, the contextual content generation system 106 utilizes large language models with zero shot learning to serve as classifiers. To illustrate, the contextual content generation system 106 probes the zero-shot classifier with the generated headline and asks the zero-shot classifier if the generated headline was engaging based on provided in-context examples.

The classifiers also form a core part of the reward model that is used to train the RL tuned content generation machine learning model as described in relation to FIG. 7. For example, the contextual content generation system 106 utilizes a reward model 716 that is based on classifiers for each of the extracted key elements. In some cases, the contextual content generation system 106 utilizes classifiers for the reward model 716 by determining a measure of central tendency (e.g., mean, median, or mode) based on generating individual precision values indicating the adherence of the digital content items to the context-specific guidelines (e.g., key elements). In some cases, the contextual content generation system 106 utilizes a Likert-scale based scoring of the adherence of the digital content items to the context-specific guidelines, with varying temperature settings (e.g., to simulate different user preferences), as well as varying user personas (tech savvy, content creator, linguistic professor).

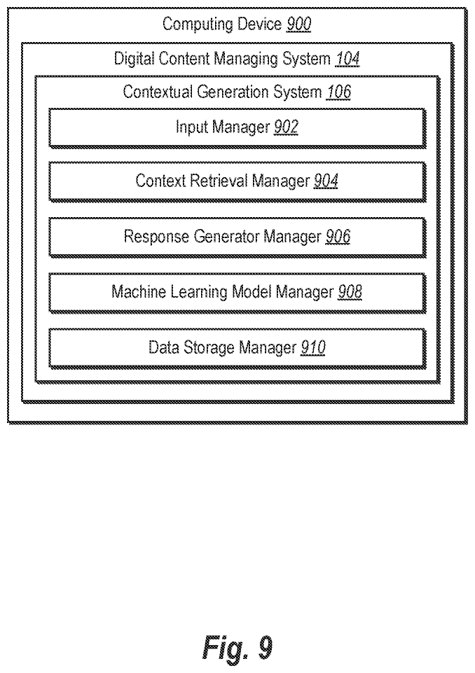

Turning now to FIG. 9, additional detail will now be provided regarding various components and capabilities of the contextual content generation system 106. In particular, FIG. 9 illustrates the contextual content generation system 106 implemented by the computing device 900 (e.g., the server device(s) 102 and/or one of the client device(s) 110 discussed above with reference to FIG. 1). Additionally, the contextual content generation system 106 is also part of the digital content management system 104. As shown in FIG. 9, the contextual content generation system 106 includes, but is not limited to, an input manager 902, a context retrieval manager 904, a response generator manager 906, and a data storage manager 910.

As just mentioned, and as illustrated in FIG. 9, the contextual content generation system 106 includes the input manager 902. In one or more embodiments, the input manager 902 retrieves or determines input comprising a content generation request. The input manager 902 incorporates the digital guideline retrieval machine learning model. Furthermore, the input manager 902 retrieves input that includes stored digital guideline documents (e.g., websites, PDFs, Word documents, digital images, text files). In addition, the input manager 902 manages key elements generated by the digital guideline retrieval machine learning model. Further, the input manager 902 manages historical digital content items used to generate an augmented prompt.

Additionally, as shown in FIG. 9, the contextual content generation system 106 includes the context retrieval manager 904. The context retrieval manager 904 generates key elements using the digital guideline retrieval machine learning model. The context retrieval manager 904 generates the key elements and provides key elements for the response generator manager 906. To illustrate, the context retrieval manager 904 utilizes the digital guideline retrieval machine learning model to retrieve key elements that correspond to one or more context-specific guidelines from among stored digital guideline documents that include PDFs, word processing documents, digital images, and text files. As part of extracting key elements, the context retrieval manager 904 generates or extracts key elements as summarized bullet-point guidelines from the stored digital guideline documents.

As further shown in FIG. 9, the contextual content generation system 106 includes the response generator manager 906 which utilizes key elements provided by the context retrieval manager 904 to generate digital content items. In particular the response generator manager 906 trains and utilizes a content generation machine learning model. To train the content generation machine learning model, the context retrieval manager 904 fine-tunes the response generator model utilizing a combination of augmented prompts, model fine-tuning, and/or reinforcement learning. In addition, the response generator manager utilizes adapter neural networks to train the content generation machine learning model. In this way, the response generator manager 906 generates and provides digital content items that adhere to context-specific guidelines utilizing the content generation machine learning model.

As also shown in FIG. 9, the contextual content generation system 106 includes the machine learning model manager 908. The machine learning model manager 908 interacts with the context retrieval manager 904 and the response generator manager 906 to manage the machine learning models. In particular, the machine learning model manager 908 manages one or more machine learning models including the digital guideline retrieval machine learning model, the content generation machine learning model, the adapter neural networks, and the reward models. For example, the machine learning model manager 908 utilizes one or more of the machine learning models based on the adherence of the generated digital content item to the context-specific guidelines (e.g., as measured by the precision value metric). To illustrate, the machine learning model manager 908 utilizes the digital guideline retrieval machine learning model to extract key elements and generate an augmented prompt. The machine learning model manager 908 utilizes the content generation machine learning model, adapter neural networks, and the reward models to generate a digital content item utilizing the augmented prompt.

Based on the adherence of the generated digital content item to the context-specific guidelines, the machine learning model manager 908 determines whether to fine-tune the content generation machine learning model utilizing adapter neural networks. Further, if the machine learning model manager 908 fine-tunes the content generation machine learning model utilizing adapter neural networks, the machine learning model manager 908 utilizes the fine-tuned content generation machine learning model to generate one or more updated content items. The machine learning model manager 908 determines adherence of the one or more updated digital content item to the context-specific guidelines. Based on the adherence of the one or more digital content item to the context-specific guidelines, the machine learning model manager 908 determines whether to utilize reinforcement learning to train the fine-tuned content generation machine learning model utilizing the reward model. In this way, the machine learning model manager 908 leverages the use of a specific combination of machine learning models to generate digital content items that adhere to the context-specific guidelines.

Additionally, as shown, the contextual content generation system 106 includes a data storage manager 910. In particular, data storage manager 910 (implemented by one or more memory devices) stores the digital content used by the contextual content generation system 106 including the digital input, content generation requests, digital guideline documents, key elements, augmented prompts, and digital content items. The data storage manager 910 facilitates the generation of digital content items by the contextual content generation system 106.

Each of the components 902-910 of the contextual content generation system 106 includes software, hardware, or both. For example, the components 902-910 include one or more instructions stored on a computer-readable storage medium and executable by processors of one or more computing devices, such as a client device or server device. When executed by the one or more processors, the computer-executable instructions of the contextual content generation system 106 causes the computing device(s) to perform the methods described herein. Alternatively, the components 902-910 include hardware, such as a special-purpose processing device to perform a certain function or group of functions. Alternatively, the components 902-910 of the contextual content generation system 106 include a combination of computer-executable instructions and hardware.

Furthermore, the components 902-910 of the contextual content generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-910 of the contextual content generation system 106 may be implemented as a stand-alone application, such as a desktop or mobile application. Furthermore, the components 902-910 of the contextual content generation system 106 may be implemented as one or more web-based applications hosted on a remote server. Alternatively, or additionally, the components 902-910 of the contextual content generation system 106 may be implemented in a suite of mobile device applications or “apps.” For example, in one or more embodiments, the contextual content generation system 106 comprises or operates in connection with digital software applications such as: ADOBE® CAMPAIGN, ADOBE® EXPRESS, ADOBE® WORKFRONT, ADOBE® JOURNEY OPTIMIZER, or ADOBE® ADVERTISING CLOUD. The foregoing are either registered trademarks or trademarks of Adobe Inc. in the United States and/or other countries.

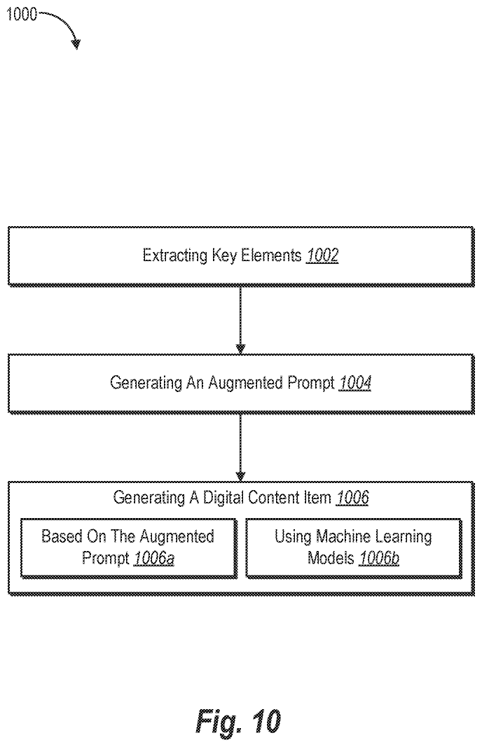

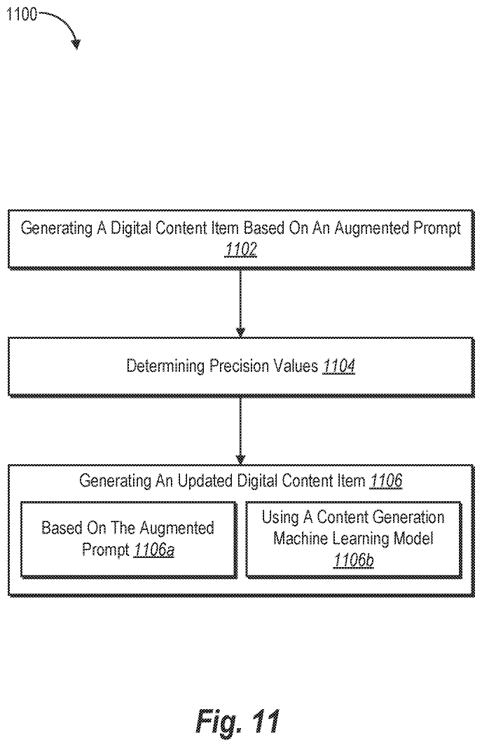

FIGS. 1-9, the corresponding text, and the examples provide a number of different methods, systems, devices, and non-transitory computer-readable media of the contextual content generation system 106. In addition to the foregoing, one or more embodiments are be described in terms of flowcharts comprising acts for accomplishing a particular result, as shown in FIGS. 10-11. The acts shown in FIGS. 10-11 may be performed in connection with more or fewer acts. Further, the acts may be performed in differing orders. Additionally, the acts described herein may be repeated or performed in parallel with one another or parallel with different instances of the same or similar acts. A non-transitory computer-readable medium includes instructions that, when executed by one or more processors, cause a computing device to perform the acts of FIGS. 10-11. In some embodiments, a system is configured to perform the acts of FIGS. 10-11. Alternatively, the acts of FIGS. 10-11 are performed as part of a computer-implemented method.

FIG. 10 illustrates a flowchart of a series of acts 1000 for using a contextual content generation system 106 to generate a contextual response in accordance with one or more embodiments. While FIG. 10 illustrates acts according to one embodiment, alternative embodiments may omit, add to, reorder, and/or modify any acts shown in FIG. 10.

FIG. 10 illustrates an example series of acts 1000 for utilizing a contextual content generation system 106 to generate a contextual response. In particular, the series of acts 1000 includes an act 1002 of extracting key elements. Specifically, in one or more embodiments, the act 1002 includes extracting, in response to a request to generate a digital content item and using one or more machine learning models of a content generation model, key elements from a digital guideline document comprising context-specific guidelines for digital content. As illustrated, in some embodiments, the series of acts 1000 also includes an act 1004 of generating an augmented prompt. Specifically, in one or more embodiments, the act 1004 includes generating, based on the request to generate the digital content item and in connection with selecting a content generation method/operation including prompt engineering or updating the one or more machine learning models of the content generation model, an augmented prompt comprising indications of the key elements from the digital guideline document. As illustrated, in some embodiments, the series of acts 1000 also includes an act 1006 of generating a digital content item with associated sub-act 1006a of generating a digital content item based on the augmented prompt and sub-act 1006b of generating a digital content item using machine learning models. Specifically, in certain embodiments, the act 1006 includes generating, based on the augmented prompt and using the one or more machine learning models, the digital content item comprising digital content corresponding to the context-specific guidelines.

In addition (or in the alternative) to the acts described above, in one or more embodiments, the contextual content generation system series of acts 1000 includes generating the augmented prompt by including examples of historical digital content items corresponding to the context-specific guidelines in the augmented prompt. Further, in one or more embodiments, the series of acts 1000 includes generating the augmented prompt by including, with the examples of historical digital content items and the indications of the key elements, content and content characteristics to include in the digital content item. In addition, in one or more embodiments, the series of acts 1000 includes parsing, utilizing a large language model of the one or more machine learning models, the digital guideline document for words, phrases, or keywords to determine bullet-point guidelines. Furthermore, in one or more embodiments, the series of acts 1000 includes generating, utilizing the large language model, the key elements comprising a list of summarized bullet-point guidelines based on the words, phrases, or keywords in the digital guideline document.

Additionally, in one or more embodiments, the series of acts 1000 includes determining that a portion of the digital content of the digital content item does not adhere to the context-specific guidelines. Moreover, in one or more embodiments, the series of acts 1000 includes modifying the one or more machine learning models by determining labeled examples of historical digital content items corresponding to the context-specific guidelines and modifying parameters of the one or more machine learning models based on the labeled examples. Additionally, in one or more embodiments, the series of acts 1000 includes determining one or more precision values indicating an adherence of the digital content item to the context-specific guidelines of the digital guideline document based on comparing the digital content item to the key elements extracted from the digital guideline document. Further, in one or more embodiments, the series of acts 1000 includes determining that the one or more precision values are below a threshold value. Furthermore, in one or more embodiments, the series of acts 1000 includes modifying the one or more machine learning models by modifying parameters of the one or more machine learning models utilizing reinforcement learning to cause the one or more precision values to meet the threshold value.

Moreover, in one or more embodiments, the series of acts 1000 includes generating, based on the augmented prompt and using the one or more machine learning models, a plurality of digital content items. Additionally, in one or more embodiments, the series of acts 1000 includes determining, for a selected key element of the key elements, a precision value indicating a ratio of a number of times the plurality of digital content items adheres to the selected key element and a total number of the plurality of digital content items. In addition, in one or more embodiments, the series of acts 1000 includes selecting, based on the precision value, between modifying parameters of the one or more machine learning models based on labeled examples and modifying parameters of the one or more machine learning models utilizing reinforcement learning.

Moreover, in one or more embodiments, the series of acts 1000 includes determining that a portion of the digital content of the digital content item does not adhere to the context-specific guidelines. In one or more embodiments, the series of acts 1000 also includes modifying parameters of an adapter neural network corresponding to the one or more machine learning models based on labeled examples corresponding to the context-specific guidelines. In addition, in one or more embodiments, the series of acts 1000 includes incorporating the adapter neural network into the one or more machine learning models. Additionally, in one or more embodiments, the series of acts 1000 includes generating a plurality of classifiers based on the key elements of the digital guideline document. Furthermore, in one or more embodiments, the series of acts 1000 includes generating, utilizing the plurality of classifiers, a plurality of precision values indicating whether the digital content adheres to the key elements of the digital guideline document. Moreover, in one or more embodiments, the series of acts 1000 includes modifying, based on the plurality of precision values, parameters of the one or more machine learning models.

FIG. 11 illustrates a flowchart of a series of acts 1100 for performing operations on a training dataset for contextual content generation system 106 to generate a contextual response in accordance with one or more embodiments. While FIG. 11 illustrates acts according to one embodiment, alternative embodiments may omit, add to, reorder, and/or modify any acts shown in FIG. 11.

FIG. 11 illustrates an example series of acts 1100 for performing operations on a training dataset for contextual content generation system for a contextual content generation system 106 to generate a contextual response. As illustrated, in one or more embodiments, the series of acts 1100 also includes an act 1102 of generating a digital content item based on an augmented prompt. Specifically, in some embodiments, the act 1102 includes generating, utilizing a content generation model, a digital content item based on an augmented prompt comprising key elements extracted from a digital guideline document comprising context-specific guidelines for digital content. In addition, in one or more embodiments, the series of acts 1100 also includes an act 1104 of determining precision values. Specifically, in certain embodiments, the act 1104 includes determining one or more precision values indicating adherence of the digital content item to the context-specific guidelines of the digital guideline document. In addition, in one or more embodiments, the series of acts 1100 also includes an act 1106 of generating an updated digital content item with associated sub-act 1106a of generating an updated digital content item based on the augmented prompt and sub-act 1106b of generating an updated digital content item using a content generation model. Specifically, in certain embodiments, the act 1106 includes generating, utilizing the content generation model comprising modified parameters based on the one or more precision values, an updated digital content item based on the augmented prompt comprising the key elements extracted from the digital guideline document.

In addition (or in the alternative) to the acts described above, in one or more embodiments, the contextual content generation system series of acts 1100 includes comparing the digital content item to the key elements extracted from the digital guideline document. Further, in one or more embodiments, the series of acts 1100 includes generating the modified parameters based on a comparison of the one or more precision values to a precision threshold.

Moreover, in one or more embodiments, the series of acts 1100 includes updating the one or more precision values indicating whether a portion of the updated digital content item adheres to the context-specific guidelines of the digital guideline document. Additionally, in one or more embodiments, the series of acts 1100 includes modifying, in response to determining the one or more precision values are below a precision threshold, parameters of the content generation model utilizing reinforcement learning with a reward model including parameters learned based on feedback from one or more user devices indicating additional precision values. Further, in one or more embodiments, the series of acts 1100 includes modifying parameters of an adapter neural network corresponding to the content generation model based on the one or more precision values. Moreover, in one or more embodiments, the series of acts 1100 includes incorporating the adapter neural network into the content generation model.

In addition, in one or more embodiments, the series of acts 1100 includes parsing the digital guideline document into a list of summarized bullet-point guidelines. Moreover, in one or more embodiments, the series of acts 1100 includes generating the key elements comprising a list of summarized bullet-point guidelines. In addition, in one or more embodiments, the series of acts 1100 includes determining one or more precision values indicating adherence of the digital content item to the context-specific guidelines by generating, utilizing a large language model to evaluate the digital content item relative to the context-specific guidelines, a plurality of precision values indicating whether the digital content adheres to the key elements of the digital guideline document.

Additionally, in one or more embodiments, the series of acts 1100 includes determining a prompt comprising a request to generate a digital content item based on context-specific guidelines contained within a digital guideline document. Moreover, in one or more embodiments, the series of acts 1100 includes extracting, using one or more machine learning models, key elements from the digital guideline document based on the context-specific guidelines. Further, in one or more embodiments, the series of acts 1100 includes generating, based on an augmented prompt that includes the prompt and the key elements and utilizing the one or more machine learning models, the digital content item comprising digital content corresponding to the context-specific guidelines. Further, in one or more embodiments, the series of acts 1100 includes generating an updated digital content item based on a comparison of the digital content item to the key elements extracted from the digital guideline document.

In addition, in one or more embodiments, the series of acts 1100 includes generating, based on the augmented prompt and utilizing the one or more machine learning models, a plurality of digital content items. Furthermore, in one or more embodiments, the series of acts 1100 includes determining, for a selected key element of the key elements, a precision value indicating a ratio of a number of times the plurality of digital content items adheres to the selected key element and a total number of the plurality of digital content items. Additionally, in one or more embodiments, the series of acts 1100 includes modifying parameters of the one or more machine learning models based on a comparison of the precision value to a precision threshold.

Moreover, in one or more embodiments, the series of acts 1100 includes generating, utilizing the one or more machine learning models, the key elements comprising a list of summarized bullet-point guidelines based on words, phrases, or keywords in the digital guideline document. Moreover, in one or more embodiments, the series of acts 1100 includes determining, utilizing a plurality of classifiers, a plurality of precision values indicating an adherence of the digital content item to the context-specific guidelines of the digital guideline document based on comparing the digital content item to the key elements extracted from the digital guideline document. Additionally, in one or more embodiments, the series of acts 1100 includes determining a measure of central tendency based on the plurality of precision values. Moreover, in one or more embodiments, the series of acts 1100 includes modifying parameters of the one or more machine learning models based on the measure of central tendency.

In addition, in one or more embodiments, the series of acts 1100 includes determining labeled examples of historical digital content items corresponding to the context-specific guidelines. Additionally, in one or more embodiments, the series of acts 1100 includes modifying parameters of the one or more machine learning models based on the labeled examples. Moreover, in one or more embodiments, the series of acts 1100 includes determining that a portion of the digital content of the digital content item does not adhere to the context-specific guidelines by determining one or more precision values indicating an adherence of the digital content item to the context-specific guidelines of the digital guideline document based on are below a threshold value. Further, in one or more embodiments, the series of acts 1100 includes modifying the one or more machine learning models by modifying the parameters of the one or more machine learning models utilizing reinforcement learning to cause the one or more precision values to meet the threshold value.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device that may be configured to perform one or more of the processes described above. One will appreciate that one or more computing devices, such as the computing device 1200 may represent the computing devices described above (e.g., server device(s) 102, client device(s) 110, and computing device 1200). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular embodiment.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
extracting, in response to a request to generate a digital content item and using one or more machine learning models of a content generation model, key elements from a digital guideline document comprising context-specific guidelines for digital content;
generating, based on the request to generate the digital content item and in connection with selecting a content generation method including prompt engineering or updating the one or more machine learning models of the content generation model, an augmented prompt comprising indications of the key elements from the digital guideline document; and
generating, based on the augmented prompt and using the one or more machine learning models, the digital content item comprising digital content corresponding to the context-specific guidelines.

2. The computer-implemented method of claim 1, further comprising generating the augmented prompt by including examples of historical digital content items corresponding to the context-specific guidelines in the augmented prompt.

3. The computer-implemented method of claim 2, further comprising generating the augmented prompt by including, with the examples of historical digital content items and the indications of the key elements, content and content characteristics to include in the digital content item.

4. The computer-implemented method of claim 1, further comprising extracting the key elements by:
parsing, utilizing a large language model of the one or more machine learning models, the digital guideline document for words, phrases, or keywords to determine bullet-point guidelines; and
generating, utilizing the large language model, the key elements comprising a list of summarized bullet-point guidelines based on the words, phrases, or keywords in the digital guideline document.

5. The computer-implemented method of claim 1, further comprising:
determining that a portion of the digital content of the digital content item does not adhere to the context-specific guidelines; and
modifying the one or more machine learning models by:
determining labeled examples of historical digital content items corresponding to the context-specific guidelines; and
modifying parameters of the one or more machine learning models based on the labeled examples.

6. The computer-implemented method of claim 1, further comprising:
determining that a portion of the digital content of the digital content item does not adhere to the context-specific guidelines by:
determining one or more precision values indicating an adherence of the digital content item to the context-specific guidelines of the digital guideline document based on comparing the digital content item to the key elements extracted from the digital guideline document; and
determining that the one or more precision values are below a threshold value; and
modifying the one or more machine learning models by modifying parameters of the one or more machine learning models utilizing reinforcement learning to cause the one or more precision values to meet the threshold value.

7. The computer-implemented method of claim 1, further comprising:
generating, based on the augmented prompt and using the one or more machine learning models, a plurality of digital content items;
determining, for a selected key element of the key elements, a precision value indicating a ratio of a number of times the plurality of digital content items adheres to the selected key element and a total number of the plurality of digital content items; and
selecting, based on the precision value, between modifying parameters of the one or more machine learning models based on labeled examples and modifying parameters of the one or more machine learning models utilizing reinforcement learning.

8. The computer-implemented method of claim 1, further comprising:
determining that a portion of the digital content of the digital content item does not adhere to the context-specific guidelines;
modifying parameters of an adapter neural network corresponding to the one or more machine learning models based on labeled examples corresponding to the context-specific guidelines; and
incorporating the adapter neural network into the one or more machine learning models.

9. The computer-implemented method of claim 1, further comprising:
generating a plurality of classifiers based on the key elements of the digital guideline document;
generating, utilizing the plurality of classifiers, a plurality of precision values indicating whether the digital content adheres to the key elements of the digital guideline document; and
modifying, based on the plurality of precision values, parameters of the one or more machine learning models.

10. A system comprising:
one or more memory devices; and
one or more processors coupled to the one or more memory devices, the one or more processors configured to cause the system to:
generate, utilizing a content generation model, a digital content item based on an augmented prompt comprising key elements extracted from a digital guideline document comprising context-specific guidelines for digital content;
determine one or more precision values indicating adherence of the digital content item to the context-specific guidelines of the digital guideline document; and
generating, utilizing the content generation model comprising modified parameters based on the one or more precision values, an updated digital content item based on the augmented prompt comprising the key elements extracted from the digital guideline document.

11. The system of claim 10, further comprising:
determining the one or more precision values indicating adherence of the digital content item to the context-specific guidelines of the digital guideline document by comparing the digital content item to the key elements extracted from the digital guideline document; and
generating the modified parameters based on a comparison of the one or more precision values to a precision threshold.

12. The system of claim 10, further comprising:
updating the one or more precision values indicating whether a portion of the updated digital content item adheres to the context-specific guidelines of the digital guideline document; and
modifying, in response to determining the one or more precision values are below a precision threshold, parameters of the content generation model utilizing reinforcement learning with a reward model including parameters learned based on feedback from one or more user devices indicating additional precision values.

13. The system of claim 10, further comprising:
modifying parameters of an adapter neural network corresponding to the content generation model based on the one or more precision values; and
incorporating the adapter neural network into the content generation model.

14. The system of claim 10, further comprising extracting the key elements by:
parsing the digital guideline document into a list of summarized bullet-point guidelines; and
generating the key elements comprising a list of summarized bullet-point guidelines.

15. The system of claim 10, further comprising determining one or more precision values indicating adherence of the digital content item to the context-specific guidelines by generating, utilizing a large language model to evaluate the digital content item relative to the context-specific guidelines, a plurality of precision values indicating whether the digital content adheres to the key elements of the digital guideline document.

16. A non-transitory computer readable medium storing executable instructions which, when executed by a processing device, cause the processing device to perform operations comprising:
determining a prompt comprising a request to generate a digital content item based on context-specific guidelines contained within a digital guideline document;
extracting, using one or more machine learning models, key elements from the digital guideline document based on the context-specific guidelines;
generating, based on an augmented prompt that includes the prompt and the key elements and utilizing the one or more machine learning models, the digital content item comprising digital content corresponding to the context-specific guidelines; and
generating an updated digital content item based on a comparison of the digital content item to the key elements extracted from the digital guideline document.

17. The non-transitory computer readable medium of claim 16, further comprising:
generating, based on the augmented prompt and utilizing the one or more machine learning models, a plurality of digital content items;
determining, for a selected key element of the key elements, a precision value indicating a ratio of a number of times the plurality of digital content items adheres to the selected key element and a total number of the plurality of digital content items; and
modifying parameters of the one or more machine learning models based on a comparison of the precision value to a precision threshold.

18. The non-transitory computer readable medium of claim 16, wherein generating an updated digital content item comprises:
determining, utilizing a plurality of classifiers, a plurality of precision values indicating an adherence of the digital content item to the context-specific guidelines of the digital guideline document based on comparing the digital content item to the key elements extracted from the digital guideline document;
determining a measure of central tendency based on the plurality of precision values; and
modifying parameters of the one or more machine learning models based on the measure of central tendency.

19. The non-transitory computer readable medium of claim 16, wherein generating an updated digital content item comprises:
determining labeled examples of historical digital content items corresponding to the context-specific guidelines; and
modifying parameters of the one or more machine learning models based on the labeled examples.

20. The non-transitory computer readable medium of claim 16, further comprising:
determining that a portion of the digital content of the digital content item does not adhere to the context-specific guidelines by determining one or more precision values indicating an adherence of the digital content item to the context-specific guidelines of the digital guideline document based on are below a threshold value; and
modifying parameters of the one or more machine learning models utilizing reinforcement learning to cause the one or more precision values to meet the threshold value.
